(19) United States
(12) Patent Application Publication
(10) Pub. No.: US 2016/0196042 A1
(43) Pub. Date: Jul. 7, 2016

(54) GESTURE ENABLED SIMULTANEOUS SELECTION OF RANGE AND VALUE

(71) Applicant: KONINKLIJKE PHILIPS N.V., Eindhoven (NL)

(72) Inventors: Niels LAUTE, Venlo (NL); Jurriën Carl GOSSELINK, Lichtenvoorde (NL)

(21) Appl. No.: 14/912,449

(22) PCT Filed: Sep. 16, 2014
(86) PCT No.: PCT/EP2014/069704

§ 371 Date: Feb. 17, 2016

(30) Foreign Application Priority Data
Sep. 17, 2013 (EP) 13184772.5

(51) Int. Cl. G06F 3/0484; G06F 3/041; G06F 3/01; G06F 3/03; G06F 3/0482; G06F 3/0488

(52) U.S. Cl. CPC G06F 3/04842; G06F 3/0482; G06F 3/04883; G06F 3/017; G06F 3/0304; G06F 3/041; G06F 2203/04104

(57) ABSTRACT

A method, gesture input devices and a computer program product are provided for gesture enabled simultaneous selection of range and value. A user makes a gesture with two fingers (210, 220) to select a range of values (e.g. one of a range of seconds, minutes or hours) and select a value from this selected range of values (e.g. if the selected range of values is hours, a value between 00-23 hours). The gesture is captured using a camera based input device or a touch input device, which detects two user input contact points (230, 240). The distance (250) between these two user input contact points (230, 240) determines the selected range of values. The selection of the value from this selected range of values is determined by an angle (280) between two imaginary lines (250, 270). The first imaginary line (250) is the line between the first (230) and second (240) user input contact point. The second imaginary line (270) is the line between an imaginary anchor point (260) and the first user input contact point (230). The distance (250) between the two fingers (210, 220) allows the user to select a range, and rotating the second finger (220) in relation to the first finger (210) allows the user to select a value, within the selected range, as user input.

### FIELD OF THE INVENTION

The present invention generally relates to methods, devices and computer program products for receiving user input and specifically to methods and computer program products for receiving user input via a gesture input device and to gesture input devices.

### BACKGROUND OF THE INVENTION

Gesture based input is widely implemented in touch input devices, such as smart phones with a touch sensitive screen. Gesture based input via a camera is also known, for example from U.S. Pat. No. 6,600,475. Such gesture based input allows a user to toggle a switch (to select an ON value or an OFF value), select a setting (e.g. mute or unmute) or select a value (e.g. select a city name from a list of city names), etc. Typically, the selection of the value is performed by the user in combination with a user interface being displayed. This provides a user feedback, for example, by displaying buttons that determine which gesture the user can input (e.g. a slide gesture to toggle a button between an OFF and an ON value). Other gestures, such as a pinch gesture or a rotate gesture, can be made anywhere on the touch sensitive screen of a smart phone to respectively decrease or increase the size of what is displayed (e.g. enlarge an image or increase a font size) or rotate what is displayed (e.g. from a portrait to a landscape mode). Given that gesture input devices play an ever larger role in a person's life, there is a need for a more user intuitive method of providing user input through a gesture input device.

EP2442220 discloses a system and a method wherein a selection of an input data field is detected. In response to the selection of the input data field, a user interface having an inner concentric circle and an outer concentric circle is generated. A contact point corresponding to a location of a touch gesture submitted via a touch-enabled input device within one of the inner concentric circle and the outer concentric circle is detected. An angular velocity of circular movement from the contact point around one of the concentric circles is measured. An input data value is adjusted at a granularity based on the contact point and at a rate based on the measured angular velocity of circular movement.

DE102011084802 relates to a display and operating device having a touch sensitive display field by means of which the parameters of a parameter vector can be changed. In order to set the parameters, a structure made of the circular or annular elements is used, on the circumference of which a corresponding contact element is positioned. Using the position of the contact element on the circumference of the ring element, the value of the parameter is coded.

### SUMMARY OF THE INVENTION

It is an object of the present invention to provide a method, gesture input devices and a computer program product enabling a more user intuitive method of providing user input. In a first aspect of the invention, a method for selecting as user input a value is provided, the method comprising the steps of: detecting, via a gesture input device, a first user input contact point, in an imaginary plane; detecting, via the gesture input device, a second user input contact point, in the imaginary plane; determining a distance, in the imaginary plane, between the first user input contact point and the second user input contact point; determining an angle, in the imaginary plane, between an first imaginary line from the first user input contact point to the second user input contact point and an second imaginary line from the first user input contact point to a predefined imaginary anchor point in the imaginary plane; selecting a range of values, from a set of such ranges of values, based on the determined distance; and selecting as user input a value, within the selected range of values, based on the determined angle. The method enables a user to simultaneously select a range and value through a gesture.

In an embodiment of the method according to the invention, the gesture input device is a touch input device arranged to detect at least two simultaneous touch inputs; and wherein the first and the second user input contact point in the imaginary plane are respectively a first and second user input contact point on the touch input device.

In an embodiment of the method according to the invention, the gesture input device is an image based input device arranged to capture an image to detect a user's hand gesture; and wherein the first and the second user input contact point in the imaginary plane are respectively the position of a first and second finger as determined through analysis of the image captured by the image based input device.

In an embodiment of the method according to the invention, the method further comprises the step of detecting a movement of the second user input contact point from a first location to a second location; wherein for the step of selecting a range of values, from a set of such ranges of values, the first location is taken as the second user input contact point in determining the distance; and wherein for the step of selecting as user input a value, within the selected range of values, the second location is taken as the second user input contact point in determining the angle.

In an embodiment of the method according to the invention, the method further comprises the step of detecting a movement of the second user input contact point from a first location to a second location; wherein for the step of selecting a range of values, from a set of such ranges of values, the second location is taken as the second user input contact point in determining the distance; and wherein for the step of selecting as user input a value, within the selected range of values, the first location is taken as the second user input contact point in determining the angle.

In an embodiment of the method according to the invention, the method further comprises the steps of: detecting a first movement of the second user input contact point from a first location to a second location; and detecting a second movement of the second user input contact point from a second location to a third location; wherein for the step of selecting a range of values, from a set of such ranges of values, the second location is taken as the second user input contact point in determining the distance; and wherein for the step of selecting as user input a value, within the selected range of values, the third location is taken as the second user input contact point in determining the angle.

In an embodiment of the method according to the invention, the method further comprises the steps of: detecting a first movement of the second user input contact point from a first location to a second location; detecting a second movement of the second user input contact point from a second location to a third location; wherein for the step of selecting a range of values, from a set of such ranges of values, the third location is taken as the second user input contact point in determining the distance; and wherein for the step of selecting as a user input a value, within the selected range of values, the second location is taken as the second user input contact point in determining the angle.

In an embodiment of the method according to the invention, detecting the first movement ends and detecting the second movement starts when any one of the following occurs: a pause in the detected movement, a variation in speed of the detected movement, a variation in the direction of the detected movement and/or a change in pressure in the detected second user input contact point.

In an embodiment of the method according to the invention, the step of selecting as a user input a value is delayed until at least one of the user input contact points is no longer detected.

In an embodiment of the method according to the invention, the step of selecting as a user input a value is skipped, cancelled, reversed or a default value is selected when any one of the following occurs: the calculated distance is smaller than a predetermined threshold or the calculated distance is larger than a predetermined threshold; and/or the calculated angle is smaller than a predetermined threshold or the calculated angle is larger than a predetermined threshold; and/or the duration of the detection of the first and/or second user input contact point is smaller than a predetermined threshold or the duration of the detection of the first and/or second user input contact point is greater than a predetermined threshold.

In an embodiment of the method according to the invention, the step of generating a user interface for displaying a visual representation of at least one range of values, from the set of such ranges of values or at least one value within said range.

In a further embodiment of the method according to the invention, the user interface comprises a plurality of displayed elements, at least partially surrounding the first user input contact point, each of said displayed elements representing at least part of at least one range of values from the set of such ranges of values.

In an embodiment of the method according to the invention, the method further comprises the step of detecting at least one additional user input contact point in the virtual plane; wherein the granularity of values in at least one range of values, from the set of such ranges, from which a value can be selected as user input is based on the number of user input contact points detected.

In a second aspect of the invention, a touch input device for receiving as user input a value is provided, the touch input device comprising: a touch sensitive screen; and a processor, coupled to the touch sensitive screen, arranged to detect multiple user input contact points; wherein the processor is further arranged to perform the steps of any of the methods of the first aspect of the invention.

In a third aspect of the invention, an image based input device for receiving as user input a value is provided, the image based input device comprising: a camera for capturing an image; and a processor, coupled to the camera, for receiving the image and processing the image to detect multiple user input contact points; wherein the processor is further arranged to perform the steps of any of the methods of the first aspect of the invention.

In a fourth aspect of the invention, a computer program product for receiving as user input a value is provided, the computer program product comprising software code portions for performing the steps of any of the methods of the first aspect of the invention, when the computer program product is executed on a computer.

It shall be understood that the method, the gesture input devices and the computer program product have similar and/or identical preferred embodiments, in particular, as defined in the dependent claims. It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following figures:

FIG. 1 shows, schematically and exemplarily, a method for receiving as user input a value, according to the first aspect of the invention;

FIG. 2 shows, schematically and exemplarily, an imaginary plane with first and second user input contact points, according to the method of the invention;

FIG. 3A, 3B show, schematically and exemplarily, an imaginary plane with first user input contact point and moving second user input contact point, according to the method of the invention;

FIG. 4 shows, schematically and exemplarily, an image based input device for receiving as user input a value, according to the method of the invention;

FIG. 5 shows, schematically and exemplarily, a touch input device for receiving as user input a value, according to the method of the invention; and

FIG. 6A, 6B, 6C, 6D show, schematically and exemplarily, a user providing as user input a value via a touch input device, according to the method of the invention.

### DETAILED DESCRIPTION OF THE FIGURES

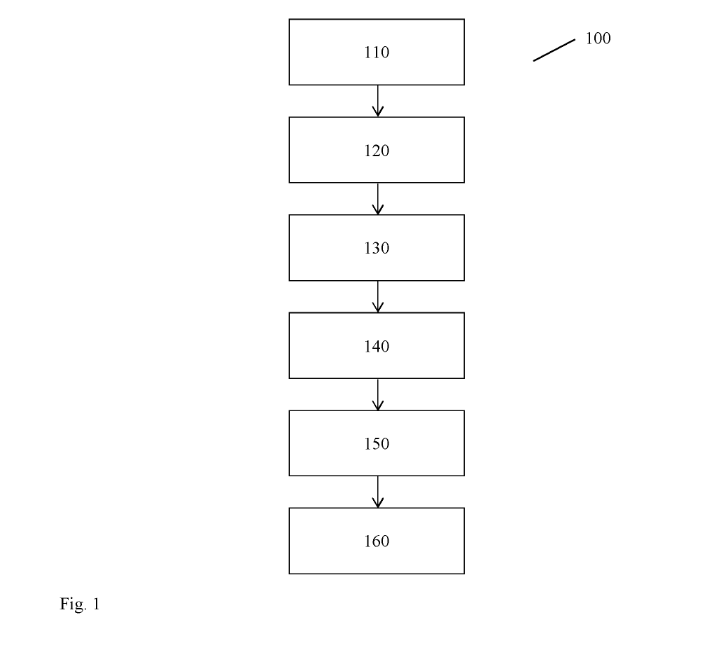

FIG. 1 shows a schematic representation of the steps of an embodiment of the method 100 according to the invention. In a first step 110 a first user input contact point, in an imaginary plane, is detected via a gesture input device. The imaginary plane can be the surface of a touch input device, such as the touch sensitive screen of a tablet computer or similar device (e.g. a smart phone, laptop, smart whiteboard or other device with a touch sensitive area). The contact point can then be a physical contact point; the location where a user touches the touch sensitive screen. As another example, the contact point can be the intersection of an imaginary plane and the user's fingertip, in an image captured by a camera. The user can then make a gesture towards a camera after which image processing determines the location of the user input contact point in the imaginary plane. The method is therefore applicable to touch input devices, image based input devices, as well as other types of gesture input devices.

In a second step 120, similar to the first step 110, a second user input contact point is detected. The (location of these) first and second user input contact points in the imaginary plane are input for the next steps.

In a third step 130, the distance (in the imaginary plane) between the first and second user input contact point is determined. The fourth step 140 comprises determining an angle between two imaginary lines. The first imaginary line is the line that runs from the first to the second user input contact point. The second imaginary line runs from a predefined imaginary anchor point in the imaginary plane to the first user input contact point. The location of the imaginary anchor point can relate to, for example, a user interface that is displayed on a touch sensitive screen of a tablet computer, or the shape of a room which is captured in the background of an image of a user making a gesture towards a camera.

The fifth step 150 takes the distance determined in the third step 130 and selects a range of values, from a set of such ranges of values, based on this distance. From this range of values, a value is selected as user input in the sixth step 160. The value selected as user input is based on the angle determined in the fourth step 140. A user can therefore in a single gesture, through at least two user input contact points simultaneously provide a range and a value within this range in order to provide as user input a value. As an example, the range of values selected can be hours (e.g. a range of 0-24 hours) if the determined distance is equal to or more than a value A (e.g. 1 centimeter, 40 pixels, 10 times the width of the user input contact point) and minutes (e.g. a range of 0-59 minutes) if it is less than A. If, in this example, the determined distance is less than A, an angle of 5 degrees can relate to the value ‘5 minutes’ whereas an angle of 10 degrees can relate to the value ‘15 minutes’. The range of values selected and the value selected as user input could however be any (range of) values, such as, numerical values (e.g. ranges ‘1, 2, 3, . . . ’; ‘10, 20, 30, . . . ’; ‘100, 200, 300, . . . ’) color points (e.g. ‘light green, dark green’, ‘light blue, dark blue’, ‘light red, dark red’), movie review related values (e.g. ‘1 star rating . . . 5 star rating’, ‘action, comedy, documentary, . . . ’), etc.

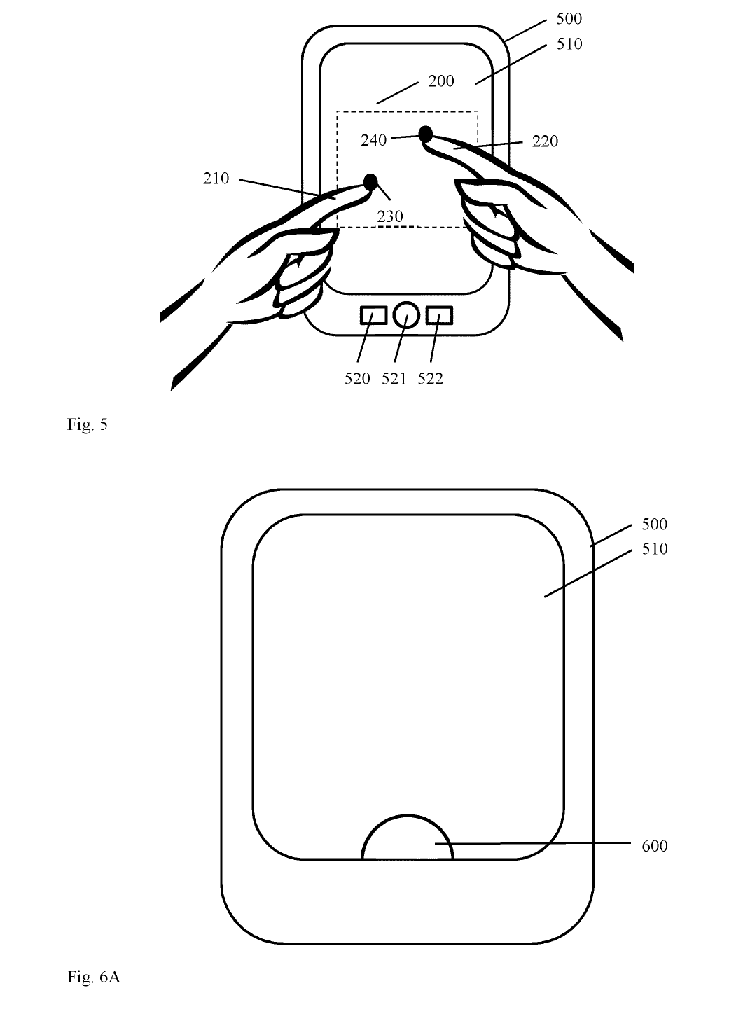

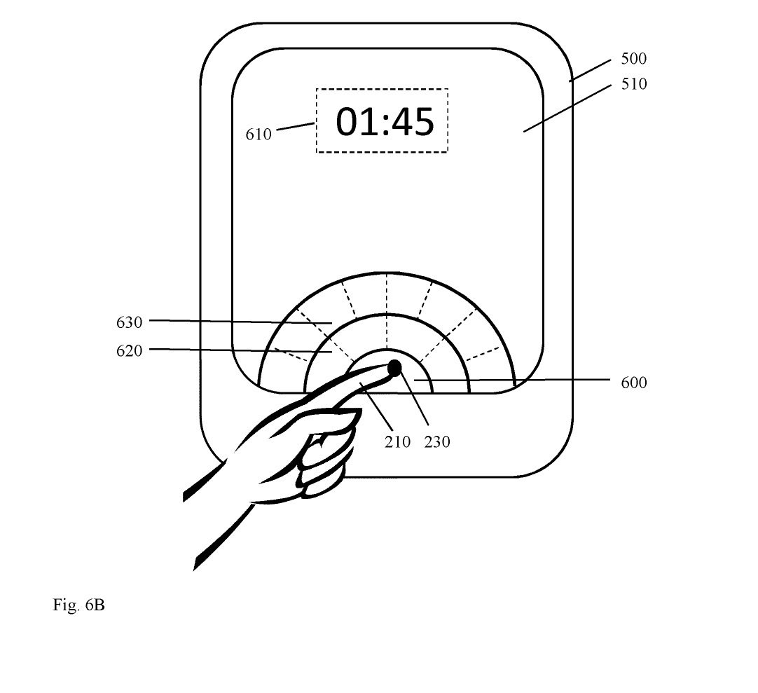

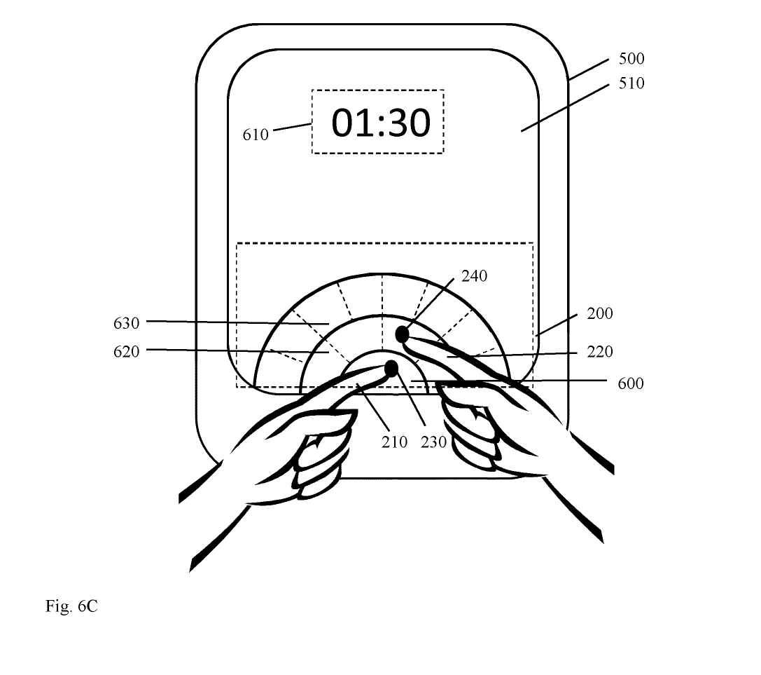

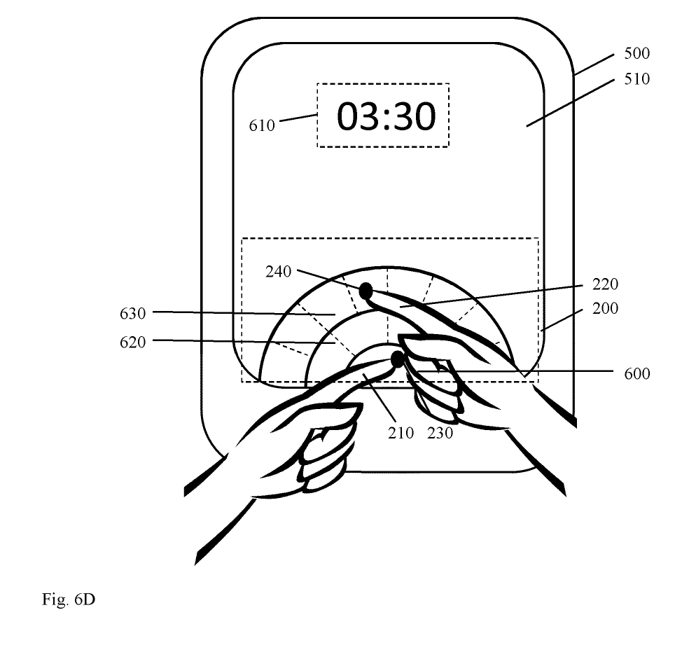

The method can be implemented in combination with a menu-like user interface (an example of which is provided in FIG. 6A, 6B, 6C, 6D), yet also without such a user interface. Given the extraordinary simplicity of the gesture and the very intuitive manner in which this allows a user to simultaneously select a range and a value within that range, the method enables ‘blind control’. A surgeon can dim the general lighting or increase the brightness of task lighting in the operating room, equipped with an image based input device, using this gesture and not look away from the patient. In this example, the surgeon simply knows where the camera is and makes the gesture towards it or the surgeon performs the gesture on a touch sensitive area embedded in a table present in the operating room. Clockwise movement of the hand dims up, counterclockwise dims down and a small distance between the first and second user input contact point (e.g. when the surgeon uses a thumb and index finger) controls the general lighting and a large distance (e.g. thumb and pinky finger) controls the task lighting.

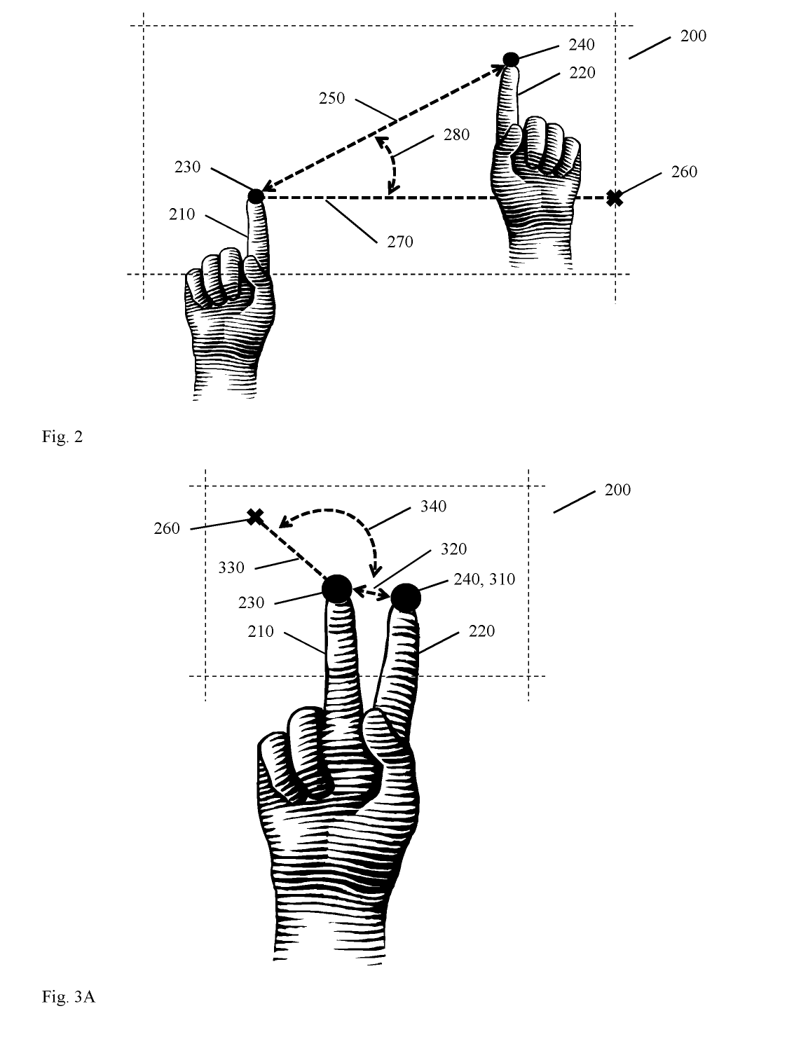

FIG. 2 shows an imaginary plane 200 with a first finger 210 and a second finger 220 providing a first user input contact point 230 and a second user input contact point 240 in the imaginary plane 200, as per an embodiment of the method according to the invention. As an example, FIG. 2 could be a bottom-up view of the imaginary plane 200 as seen through the touch sensitive screen of a tablet computer (not shown), or the image as captured by a camera (not shown) towards which the user is making a gesture.

The imaginary line 250 between the first user contact point 230 and the second user contact point 240 is the basis for selecting a range of values from a set of such ranges of values. The length of this line, in the imaginary plane 200, determines which range of values is selected. The predefined imaginary anchor point 260 can be located anywhere in the imaginary plane 200. As an example, the predefined imaginary anchor point 260 can relate to a point displayed in a user interface via the touch sensitive screen of a tablet computer. As another example, the predefined imaginary anchor point 260 can relate to a physical feature of the touch sensitive screen of a smartphone such as one of the corners of the screen. As yet another example, the predefined imaginary anchor point 260 can relate to a horizontal line detected in an image captured by a camera towards which the user is making a gesture (e.g. the intersection of the detected horizontal line, such as the corner between floor and wall, and the edge of the captured image). The angle 280 between an imaginary line 270 between the predefined imaginary anchor point 260 and the first user contact point 230, and the imaginary line 250 between the first user contact point 230 and the second user contact point 240, is the basis for selecting a value out of the selected range of values.

Determining what is the first 230 and second 240 user input contact point can be based on which user input contact point 230, 240 is detected first (e.g. where the user first touches a touch sensitive screen of a tablet computer), which user input contact point 230, 240 is closest to the edge of the touch sensitive screen of the tablet computer, or closest to a displayed menu item on the touch sensitive screen. Other examples comprise the left most user input contact point or the most stationary user input contact point being detected as the first user input contact point 230.

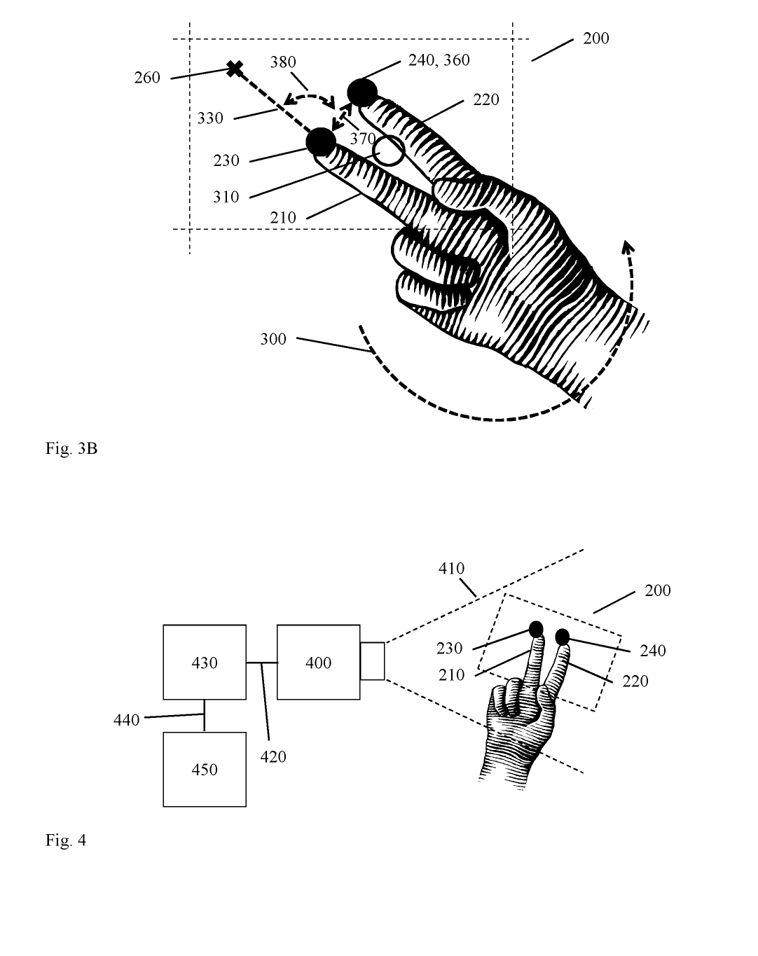

FIGS. 3A and 3B illustrate an embodiment of the method according to the invention wherein the user moves 300 his second finger 220 (e.g. across the touch sensitive screen). In this example, the second finger 220 moving results in the second user input contact point 240 moving from a first location 310 to a second location 360. The distance 320, 370 between the first user input contact point 230 and the second user input contact point 240 remains the same in this example. The angle 340, 380 between the imaginary line 330 between the predefined imaginary anchor point 260 and the first user contact point 230, and the imaginary line 320, 370 between the first user contact point 230 and the second user contact point 240 changes however. In this example, the user therefore selects a range of values from a set of such ranges of values and then changes the selection of the value from this selected range of values by moving the second user contact point 340 from the first location 310 to the second location 360.

In various embodiments, movement of the first 230 and/or second 240 user input contact point(s) are detected. As a first example, the first location 310 where the user puts down his second finger 220 can be the basis for determining the distance 320 and the second location 360 the basis for determining the angle 380. This allows a user to select a range first (e.g. ‘days’ selected from the set of ranges ‘days’, ‘months’, ‘years’) and then freely change the distance 370 between the first 210 and second 220 finger (and therefore the distance between the first 230 and second 240 user input contact point) without this changing the selected range. Vice versa, the user can first select a value and then select a range if the angle 340 is determined based on the first location 310 and the distance 370 is determined based on the second location 360. This can allow a user to first select a brightness level (e.g. ‘dim 10%’ selected from the set of ranges dim ‘0, 10, 20 . . . 90, 100’) and then select a color range (e.g. ‘soft white’, ‘cool white’, ‘daylight’).

As another example, the first location 310 can be used merely to trigger the event of showing the user the current value (e.g. through a user interface), after which the second location 360 that the user's finger moves to is used to determine the range and the third location (not shown) that the user's finger moves to is used to determine the value. Again, this can be implemented vice versa with the second location 360 determining the value and the third location determining the range. As yet another example, multiple user input values can be received through this method, such as when the first location 310 determines both distance 320 and angle 340 for a first user input of a value and the second location 360 determines both distance 370 and angle 380 for a second user input of a value. Also, in an embodiment the first user contact point 230 can move from a first location to a second location (not shown), where the imaginary anchor point 260 moves so as to remain in the same relative position to the first user contact point 230. This prevents the user from having to keep the first user contact point 230 in (exactly) the same area while performing the gesture.

In other embodiments, aspects of the movement detected can determine the first 310, second 360 and third location, such as when the second user input contact point 240 moves from the first 310 to the second 360 location with a speed of 1 centimeter per second and from the second 360 to the third location with a speed of 2 centimeters per second. Likewise, a change of direction of the detected movement or a change in pressure (e.g. when a touch input device with a pressure sensitive touch interface is used) can be the basis for determining first 310, second 360 and third locations. As a further example, the step of selecting as user input a value can be delayed until the second user input contact point 240 remains in the same location for a predetermined amount of time, preventing accidentally selecting an incorrect value; or no value is selected if the user removes both fingers 210, 220 from the imaginary plane 200 at the same time, allowing a user to ‘cancel’ the gesture.

FIG. 4 shows an image based input device for receiving as user input a value according to the method of the invention. A camera 400 has a field of view 410 in which a user (not shown) makes a gesture towards the camera. The camera 400 has a (wired or wireless) connection 420 to a processor 430. The processor 430 analyzes the image captured by the camera 400 and detects a first 230 and second 240 user input contact point in an imaginary plane 200. As an example, the camera 400 can be stereoscopic and create a three dimensional image allowing the processor 430 to more accurately determine the distance between the first 230 and second 240 user input contact point in the imaginary plane 200, as well as the angle between the first imaginary line (not shown) from the first user input contact point 230 to the second user input contact point 240, and the second imaginary line (not shown) from the first user input contact point 230 to a predefined imaginary anchor point (not shown) in the imaginary plane 200. The processor 430 further selects a range of values, from a set of such ranges of values, based on the determined distance; and selects as user input a value, within the range of values, based on the determined angle. Through a (wired or wireless) connection 440 between the processor 430 and a user device 450 the value selected as user input can be transmitted to the user device 450. As an example, the user device 450 can be a television and the gesture made by the user allows for selection of a range (e.g. TV channels or TV volume settings) and a value within the selected range (e.g. ‘Channel 1 . . . Channel 20’ or ‘Sound off, low volume . . . high volume’). As another example, the user device 450 can be a wall mounted clock and the gesture allows the user to set the time by selecting a range (e.g. hours or minutes) and a value (e.g. ‘00 to 23 hours’ or ‘00 to 59 minutes’). The camera 400 and processor 430 can, for example, be integrated in the user device 450 (e.g. TV, wall mounted clock) or be implemented in a (smart) phone with a camera.

FIG. 5 shows a tablet computer 500 with a touch sensitive screen 510 for receiving as user input a value according to the method of the invention. The user touches with a first 210 and second 220 finger the touch sensitive screen 510. The illustration shows the user touching the touch sensitive screen 510 with one finger 210, 220 of each hand, however fingers from the same hand can be used or two users can each use one finger. In a further example, multiple fingers are used, other body parts are used or a stylus like device is used instead of or in addition to a finger. The tablet computer 500 detects via the touch sensitive screen 510 a first 230 and second 240 user input contact point and selects as user input a value according to the method of the invention. The selected value can be used, for example, as user input in a dialogue screen in an application or a system menu. As a further example, the user input can be used to change settings (e.g. volume, brightness) of the tablet computer 500 without a user interface being displayed on the touch sensitive screen 510 (e.g. the screen 510 can be off or the user interface shown on the screen 510 does not relate to the action performed by the gesture). As a further example, the tablet computer (500) can have physical buttons (520, 521, 522) that allow a user to fine tune the selection of the value, such as when the user makes first selection using a gesture and then decreases the value using a physical button (520), increases the value using a physical button (522) and selects the value as final user input using a physical button (521).

FIG. 6A, 6B, 6C, 6D show multiple steps of a user providing as user input a value via a tablet computer 500 according to the method of the invention. In a first step (FIG. 6A) the tablet computer 500 provides, through the touch sensitive screen 510, a button 600. This button can be visible or invisible (e.g. a ‘hot zone’). When the user touches the button 600 (FIG. 6B) the current value 610 is shown (“01:45”). In this example, the current value 610 is a timer function set to count down from 1 hour and 45 minutes to zero (e.g. a cooking timer). Two elements are displayed 620, 630 on the touch sensitive screen 510, each element relating to a range of values. The first element displayed 620 partially surrounds the button 600 where the first user input contact point 230 was detected. The second element displayed 630 partially surrounds the first element 620. The first element 620 shows, in this example, four values relating to selecting minutes in increments of 15 minutes (“0 minutes”, “15 minutes”, “30 minutes” and “45 minutes”). The second element displayed shows, in this example, eight values relating to selecting hours (“0, 1 . . . 6, 7 hours”).

In a next step (FIG. 6C) the user uses a second finger 220 to create a second user input contact point 240 in the first element 620. The first 230 and second 240 user input contact points are located in the imaginary plane 200 that is, in this example, (a part of) the surface of the touch sensitive screen 510. In this example the user selects the value “30 minutes” from the range “minutes in 15 minute increments” that the first element displayed is related to. The user then (FIG. 6D) moves the second user input contact point 240 to an area of the second element 630 displayed on the touch sensitive screen 510. The user thereby selects the value “3 hours” from the range (“0, 1 . . . 6, 7 hours”) related to this second displayed element 630. After each selection of a value from a range of values, the current value 610 is updated; first from “01:45” to “01:30” as the value “30 minutes” is selected and then from “01:30” to “03:30” as the value “3 hours” is selected. The user can then (not shown) move the first 210 and second 220 finger away from the touch sensitive screen 510 of the table computer 500, after which the tablet computer 500 resorts to the first step (FIG. 6A).

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. In the unit claims enumerating several means, several of these means can be embodied by one and the same item of hardware. The usage of the words first, second and third, etcetera do not indicate any ordering. These words are to be interpreted as names. No specific sequence of acts is intended to be required unless specifically indicated.

1. A method for receiving as user input a value, the method comprising the steps of:
detecting, via a gesture input device, a user input contact point, in an imaginary plane;
determining a distance, in the imaginary plane, between a reference point and the user input contact point;
determining an angle, in the imaginary plane, between a first imaginary line from the reference point to the user input contact point and a second imaginary line from the reference point to a predefined imaginary anchor point in the imaginary plane;
selecting a range of values, from a set of such ranges of values, based on the determined distance; and
selecting as user input a value, within the selected range of values, based on the determined angle,
characterized in that said reference point is an additional user input contact point, the additional user input contact point and the user input contact point respectively defining a first and a second user input contact point.

2. The method of claim 1, wherein the gesture input device is a touch input device arranged to detect at least two simultaneous touch inputs; and wherein the first and the second user input contact point in the imaginary plane are respectively a first and second user input physical contact point on the touch input device.

3. The method of claim 1, wherein the gesture input device is an image based input device arranged to capture an image to detect a user's hand gesture; and wherein the first and the second user input contact point in the imaginary plane are respectively the position of the intersection of the imaginary plane and a first and second finger of the user in an image captured by a camera of the image based input device as determined through analysis of the captured image by the image based input device.

4. The method of claim 1, further comprising the step of detecting a movement of the second user input contact point from a first location to a second location;
wherein for the step of selecting a range of values, from a set of such ranges of values, the first location or the second location is taken as the second user input contact point in determining the distance; and
wherein for the step of selecting as user input a value, within the selected range of values, the second location or the first location, respectively, is taken as the second user input contact point in determining the angle.

5. The method of claim 1, further comprising the steps of:
detecting a first movement of the second user input contact point from a first location to a second location; and
detecting a second movement of the second user input contact point from a second location to a third location;
wherein for the step of selecting a range of values, from a set of such ranges of values, the second location or the third location is taken as the second user input contact point in determining the distance; and
wherein for the step of selecting as user input a value, within the selected range of values, the third location or the second location, respectively is taken as the second user input contact point in determining the angle.

6. The method of claim 5, wherein detecting the first movement ends and detecting the second movement starts when at least one of the following occurs: a pause in the detected movement, a variation in speed of the detected movement, a variation in the direction of the detected movement, and a change in pressure in the detected second user input contact point.

7. The method of claim 1, wherein the step of selecting as a user input a value is delayed until at least one of the user input contact points is no longer detected.

8. The method of claim 1, wherein the step of selecting as a user input a value is skipped, cancelled, reversed or a default value is selected when at least one of the following occurs: the calculated distance is smaller than a predetermined threshold, the calculated distance is larger than a predetermined threshold, the calculated angle is smaller than a predetermined threshold, the calculated angle is larger than a predetermined threshold, the duration of the detection of the first or the second user input contact point is smaller than a predetermined threshold, and the duration of the detection of the first or second user input contact point is greater than a predetermined threshold.

9. The method of claim 1, further comprising the step of generating a user interface for displaying a visual representation of at least one range of values, from the set of such ranges of values or at least one value within said range.

10. The method of claim 9, wherein the user interface comprises a plurality of displayed elements, at least partially surrounding the first user input contact point, each of said displayed elements representing at least part of at least one range of values from the set of such ranges of values.

11. The method of claim 1, further comprising the step of detecting at least one additional user input contact point in the virtual plane; wherein the granularity of values in at least one range of values, from the set of such ranges, from which a value can be selected as user input is based on the number of user input contact points detected.

12. A touch input device for receiving as user input a value, the device comprising:
a touch sensitive screen; and
a processor, coupled to the touch sensitive screen, and arranged to detect multiple user input contact points;
wherein the processor is further arranged to perform the steps of the method of claim 1.

13. An image based input device for receiving as user input a value, the device comprising:
a camera for capturing an image; and
a processor, coupled to the camera, and arranged for receiving and processing the image to detect multiple user input contact points;
wherein the processor is further arranged to perform the steps of the method of claim 1.

14. A computer program product for receiving as user input a value, comprising software code portions for performing the steps of claim 1, when the computer program product is executed on a computer.
